(19) United States
(12) Patent Application Publication
(10) Pub. No.: US 2026/0066716 A1
(43) Pub. Date: Mar. 5, 2026

(54) TRANSVERSE FLUX MACHINE WITH REDUCED TORQUE RIPPLE

(71) Applicant: Steering Solutions IP Holding Corporation, Saginaw, MI (US)

(72) Inventors: Anik Chowdhury, Auburn Hills, MI (US); Shuvajit Das, Sterling Heights, MI (US); Connor Juvonen, Flushing, MI (US); Alejandro J. Pina Ortega, Grand Blanc, MI (US); Rong Yang, Troy, MI (US)

(21) Appl. No.: 18/816,684

(22) Filed: Aug. 27, 2024

(51) Int. Cl. H02K 1/14; B62D 5/04; H02K 1/16; H02K 1/2706; H02K 1/2786

(52) U.S. Cl. CPC H02K 1/145; B62D 5/0409; H02K 1/16; H02K 1/2706; H02K 1/2786; H02K 2201/12

(57) ABSTRACT

A transverse flux machine (TFM) includes a rotor having permanent magnets generating a magnetic flux in a circumferential direction; and a stator including a plurality of stators cores each holding a winding and being configured to direct the magnetic flux in a radial direction and an axial direction. Each of the stator cores has one of: a gear shape with two sets of protrusions flanking the winding and extending radially toward the rotor, or a claw-pole shape including two sets of teeth extending radially toward the rotor and wrapping axially over the winding. The rotor has a first axial length that is longer than a total axial length of the stator in case the stator cores have the gear shape, or the rotor has a second axial length that is shorter than the total axial length of the stator in case the stator cores have the claw-pole shape.

### CROSS REFERENCE TO RELATED APPLICATIONS

None.

### TECHNICAL FIELD

This disclosure relates to transverse flux electric machines. This disclosure also relates to applications of such transverse flux electric machines in a handwheel actuator of a steering system for a vehicle.

### BACKGROUND

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

Steer by wire (SbW) is a direct evolution of the EPS system where there is no mechanical coupling between the handwheel and the steering rack. An EPS system may include a single actuator with the sole purpose of providing assist to the driver during steering actions. However, on the SbW system, there may be two electric actuators/motors with different functionalities. The electric actuator attached to the rack in a SbW system is called the roadwheel actuator (RWA), whereas the actuator on the driver side is known as the handwheel actuator (HWA). The RWA has the same assist providing function as an EPS system actuator. The HWA on the other hand acts more as a feedback motor rather than providing assist to the driver. In the absence of the HWA the handwheel on a SbW system would just freewheel because of the absence of any mechanical coupling/friction. The HWA, because of its' functionality opens a wide array of design related opportunities.

Based on their functionality, the torque speed curves of the different actuators used in steering systems may also be different. The very different operating domains of the EPS/RWA and the HWA motivates design exploration for HWA technology.

Transverse flux machines (TFMs) are known for their relatively high volumetric and gravimetric power densities. Additionally, TFMs may be constructed with relatively simple ring windings, providing ease of manufacturing process and reduced costs. However, conventional multi-phase TFMs have inherently imbalanced flux linkages, which can cause high second-order torque ripple. Such second-order torque ripple can have detrimental effects, such as noise and vibration.

### SUMMARY

This disclosure relates generally to transverse flux electric machines.

An aspect of the disclosed embodiments includes a transverse flux machine (TFM). The TFM includes: a rotor configured to rotate about an axis and having a plurality of permanent magnets arranged to generate a magnetic flux in a circumferential direction; and a stator including a plurality of stators cores stacked axially and each being configured to direct the magnetic flux in each of a radial direction and an axial direction, and each of the stator cores holding at least one winding. Each of the stator cores has one of: a gear shape or a claw-pole shape. The gear shape includes a first plurality of protrusions each extending in a radial direction toward the rotor, and a second plurality of protrusions each extending in a radial direction toward the rotor, with the second plurality of protrusions being axially spaced apart from the first plurality of protrusions with the at least one winding substantially entirely located axially between the first plurality of protrusions and the second plurality of protrusions. The claw-pole shape includes a first plurality of teeth each extending in a radial direction toward the rotor and wrapping over the at least winding in a first axial direction, and a second plurality of teeth each extending in a radial direction toward the rotor and wrapping over the at least winding in a second axial direction opposite the first axial direction. The rotor has a first axial length that is longer than a total axial length of the stator in case the stator cores have the gear shape, or the rotor has a second axial length that is shorter than the total axial length of the stator in case the stator cores have the claw-pole shape.

Another aspect of the disclosed embodiments includes a steer-by-wire system for a vehicle. The steer-by-wire system includes a handwheel actuator coupled to apply a torque to a steering wheel. The handwheel actuator includes a transverse flux machine (TFM). The TFM includes: a rotor configured to rotate about an axis and having a plurality of permanent magnets arranged to generate a magnetic flux in a circumferential direction; and a stator including a plurality of stators cores stacked axially and each being configured to direct the magnetic flux in each of a radial direction and an axial direction, and each of the stator cores holding at least one winding. Each of the stator cores has one of: a gear shape or a claw-pole shape. The gear shape includes a first plurality of protrusions each extending in a radial direction toward the rotor, and a second plurality of protrusions each extending in a radial direction toward the rotor, with the second plurality of protrusions being axially spaced apart from the first plurality of protrusions with the at least one winding substantially entirely located axially between the first plurality of protrusions and the second plurality of protrusions. The claw-pole shape includes a first plurality of teeth each extending in a radial direction toward the rotor and wrapping over the at least winding in a first axial direction, and a second plurality of teeth each extending in a radial direction toward the rotor and wrapping over the at least winding in a second axial direction opposite the first axial direction. The rotor has a first axial length that is longer than a total axial length of the stator in case the stator cores have the gear shape, or the rotor has a second axial length that is shorter than the total axial length of the stator in case the stator cores have the claw-pole shape.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an electric power steering (EPS) system according to the principles of the present disclosure.

FIG. 2 generally illustrates an EPS system according to the principles of the present disclosure.

FIG. 3 generally illustrates a steer-by-wire (SbW) steering system according to the principles of the present disclosure.

FIG. 4 is a schematic diagram of a dual wound motor drive system according to the principles of the present disclosure.

FIG. 5 shows a graph illustrating torque-speed curves of steering system actuators according to the principles of the present disclosure.

FIG. 6 shows a graph illustrating a torque-speed curve of a direct drive handwheel actuator in a SbW steering system.

FIG. 7 shows a cross-sectional diagram of a radial flux machine (RFM), according to the principles of the present disclosure.

FIG. 8 shows a cross-sectional diagram of an axial flux machine (AFM), according to the principles of the present disclosure.

FIG. 9 shows a cross-sectional diagram of a transverse flux machine (TFM), according to the principles of the present disclosure.

FIG. 10 shows a perspective fragmentary view of a TFM with a flux-concentrating outer rotor and a single-piece stator, according to the principles of the present disclosure.

FIG. 11 shows a perspective view of a stator in an external rotor TFM, according to the principles of the present disclosure.

FIG. 12 shows a perspective view of a stator in an internal rotor TFM, according to the principles of the present disclosure.

FIG. 13 shows a perspective fragmentary view of a second TFM with a gear-style configuration.

FIG. 14 shows a perspective view of a single gear-style stator ring of an external rotor TFM and with a dual-wound configuration.

FIG. 15 shows a graph illustrating flux linkage imbalance between phases of a three-phase TFM with a gear-style stator and during no-load operation.

FIG. 16 shows a graph illustrating peak absolute values of the positive and negative flux linkages in the three-phase TFM with the gear-style stator and during no-load operation.

FIG. 17 shows a graph illustrating first order harmonics of flux linkage in the three-phase TFM with the gear-style stator and during no-load operation.

FIG. 18 shows a perspective fragmentary view of a third TFM with a claw pole configuration.

FIG. 19 shows a perspective view of a single claw pole-style stator ring of an external rotor TFM.

FIG. 20 shows a fragmentary view of the claw pole-style stator ring and with a single-wound configuration.

FIG. 21 shows a graph illustrating flux linkage imbalance between phases of a three-phase TFM with a claw pole-style stator and during no-load operation.

FIG. 22 shows a graph illustrating peak absolute values of the positive and negative flux linkages in the three-phase TFM with the claw pole-style stator and during no-load operation.

FIG. 23 shows a graph illustrating first order harmonics of flux linkage in the three-phase TFM with the claw pole-style stator and during no-load operation.

FIG. 24 shows a cut-away fragmentary side view of a fourth TFM, according to the principles of the present disclosure.

FIG. 25 shows a graph illustrating positive and negative peak values of flux linkage in the fourth TFM, during no-load operation.

FIG. 26 shows a graph illustrating first order harmonics of flux linkage in the fourth TFM, during no-load operation.

FIG. 27 shows a cut-away fragmentary side view of a fifth TFM, according to the principles of the present disclosure.

FIG. 28 shows a graph illustrating positive and negative peak values of flux linkage in the fifth TFM, during no-load operation.

FIG. 29 shows a graph illustrating first order harmonics of flux linkage in the fifth TFM, during no-load operation.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electric power steering system (EPS) system, an SbW steering system, a hydraulic steering system, or other suitable steering system. The steering system of such a vehicle typically controls various aspects of vehicle steering including providing steering assist to an operator of the vehicle, controlling steerable wheels of the vehicle, and the like.

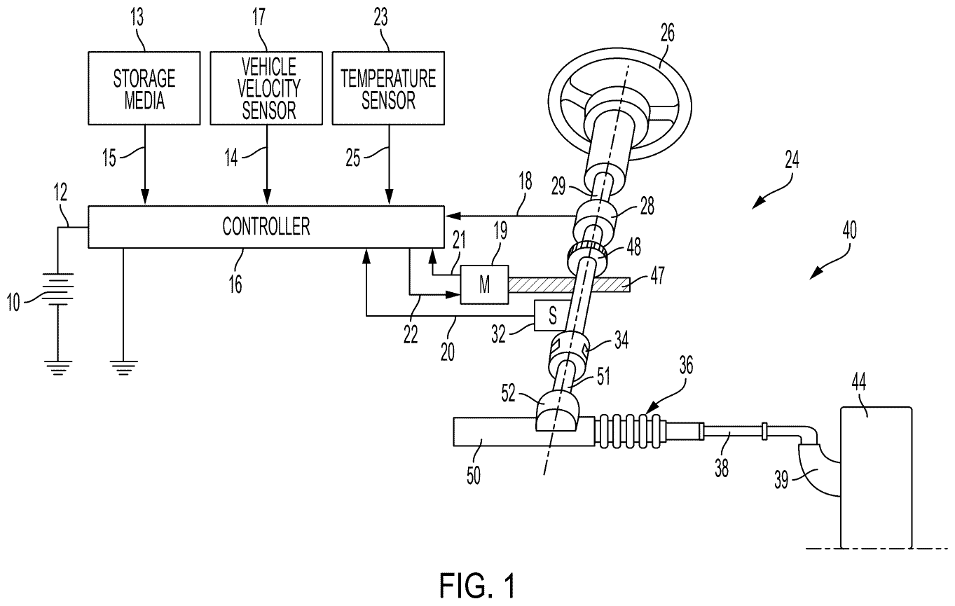

FIG. 1 is a schematic diagram of an EPS system 40 suitable for implementation of the disclosed techniques. The EPS system 40 includes a steering mechanism 36, which includes a rack-and-pinion type mechanism having a toothed rack (not shown) within housing 50 and a pinion gear (also not shown) located under gear housing 52. As the operator input, hereinafter denoted as a steering wheel 26 (e.g. a handwheel and the like), is turned, the upper steering shaft 29 turns and the lower steering shaft 51, connected to the upper steering shaft 29 through universal joint 34, turns the pinion gear. Rotation of the pinion gear moves the rack, which moves tie rods 38 (only one shown) in turn moving the steering knuckles 39 (only one shown), which turn a steerable wheel(s) 44 (only one shown).

Electric power steering assist is provided through the steering motion control system generally designated by reference numeral 24 and includes the controller 16 and an electric machine, which could be a permanent magnet synchronous motor, and is hereinafter denoted as motor 19. The controller 16 is powered by the vehicle power supply 10 through supply conductors 12. The controller 16 receives a vehicle speed signal 14 representative of the vehicle velocity from a vehicle velocity sensor 17. Steering angle is measured through position sensor 32, which may be an optical encoding type sensor, variable resistance type sensor, or any other suitable type of position sensor, and supplies to the controller 16 a position signal 20. Motor velocity may be measured with a tachometer, or any other device, and transmitted to controller 16 as a velocity signal 21. A motor velocity denoted om may be measured, calculated or a combination thereof. For example, the motor velocity dm may be calculated as the change of the motor position as measured by a position sensor 32 over a prescribed time interval. For example, motor speed ωₘ may be determined as the derivative of the motor position θₘ with respect to time. It will be appreciated that there are numerous well-known methodologies for performing the function of a derivative.

As the steering wheel 26 is turned, torque sensor 28 senses the torque applied to the steering wheel 26 by the vehicle operator. The torque sensor 28 may include a torsion bar (not shown) and a variable resistive-type sensor (also not shown), which outputs a torque signal 18 to controller 16 in relation to the amount of twist on the torsion bar. Although this is one type of torque sensor, any other suitable torque-sensing device used with known signal processing techniques will suffice. In response to the various inputs, the controller sends a command 22 to the motor 19, which supplies torque assist to the steering system through worm 47 and worm gear 48, providing torque assist to the vehicle steering.

It should be noted that although the disclosed embodiments are described by way of reference to motor control for electric steering applications, it will be appreciated that such references are illustrative only and the disclosed embodiments may be applied to any motor control application employing an electric motor, e.g., steering, valve control, and the like. Moreover, the references and descriptions herein may apply to many forms of parameter sensors, including, but not limited to torque, position, speed and the like. It should also be noted that reference herein to electric machines including, but not limited to, motors, hereafter, for brevity and simplicity, reference will be made to motors only without limitation.

In the steering motion control system 24 as depicted, the controller 16 utilizes the torque, position, and speed, and like, to compute a command(s) to deliver the required output power. Controller 16 is disposed in communication with the various systems and sensors of the motor control system. Controller 16 receives signals from each of the system sensors, quantifies the received information, and provides an output command signal(s) in response thereto, in this instance, for example, to the motor 19. Controller 16 is configured to develop the corresponding voltage(s) out of inverter (not shown), which may optionally be incorporated with controller 16 and will be referred to herein as controller 16, such that, when applied to the motor 19, the desired torque or position is generated. In one or more examples, the controller 16 operates in a feedback control mode, as a current regulator, to generate the command 22. Alternatively, in one or more examples, the controller 16 operates in a feedforward control mode to generate the command 22. Because these voltages are related to the position and speed of the motor 19 and the desired torque, the position and/or speed of the rotor and the torque applied by an operator are determined. A position encoder is connected to the steering shaft 51 to detect the angular position θ. The encoder may sense the rotary position based on optical detection, magnetic field variations, or other methodologies. Typical position sensors include potentiometers, resolvers, synchros, encoders, and the like, as well as combinations comprising at least one of the forgoing. The position encoder outputs a position signal 20 indicating the angular position of the steering shaft 51 and thereby, that of the motor 19.

Desired torque may be determined by one or more torque sensors 28, which transmit the torque signals 18 indicative of an applied torque. Such a torque sensor 28 and the torque signals 18 therefrom, as may be responsive to a compliant torsion bar, spring, or similar apparatus (not shown) configured to provide a response indicative of the torque applied.

In one or more examples, a temperature sensor 23 is located at the motor 19. Preferably, the temperature sensor 23 is configured to directly measure the temperature of the sensing portion of the motor 19. The temperature sensor 23 transmits a temperature signal 25 to the controller 16 to facilitate the processing prescribed herein and compensation. Typical temperature sensors include thermocouples, thermistors, thermostats, and the like, as well as combinations comprising at least one of the foregoing sensors, which when appropriately placed provide a calibratable signal proportional to the particular temperature.

The position signal 20, velocity signal 21, and torque signals 18 among others, are applied to the controller 16. The controller 16 processes all input signals to generate values corresponding to each of the signals resulting in a rotor position value, a motor speed value, and a torque value being available for the processing in the algorithms as prescribed herein. Measurement signals, such as the above mentioned are also commonly linearized, compensated, and filtered as desired to enhance the characteristics or eliminate undesirable characteristics of the acquired signal. For example, the signals may be linearized to improve processing speed, or to address a large dynamic range of the signal. In addition, frequency or time based compensation and filtering may be employed to eliminate noise or avoid undesirable spectral characteristics.

In order to perform the prescribed functions and desired processing, as well as the computations therefore (e.g., the identification of motor parameters, control algorithm(s), and the like), controller 16 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller 16 may include input signal processing and filtering to enable accurate sampling and conversion or acquisitions of such signals from communications interfaces.

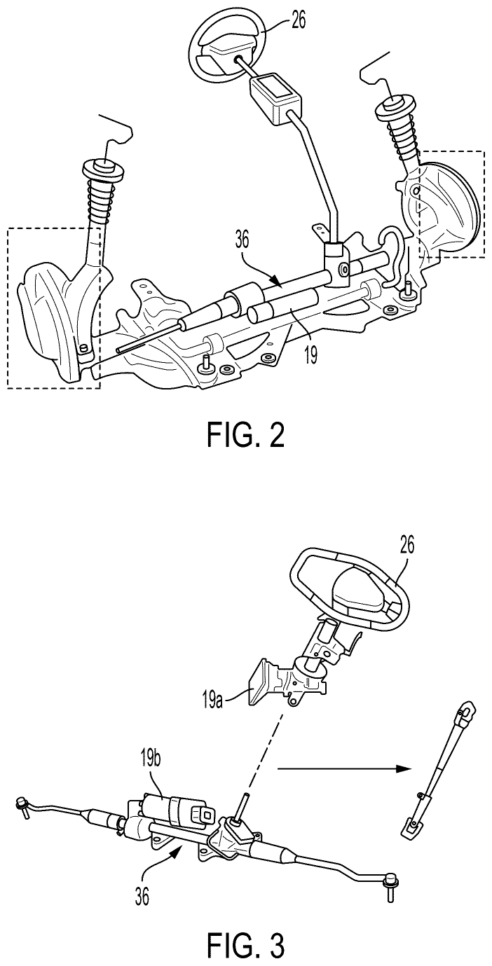

FIG. 2 generally illustrates an EPS system, and FIG. 3 generally illustrates a steer-by-wire (SbW) steering system. The EPS system of FIG. 2 may be similar or identical to the EPS system 40 of FIG. 1, except with the motor 19 mounted directly to the steering mechanism 36. The SbW system of FIG. 3 may be similar or identical to the EPS system 40 of FIG. 1, except without any physical linkage between the steering wheel 26 and the steerable wheels 44, and with two separate and independent motors 19a, 19b. As shown, the SbW system includes a first motor 19a, also called a roadwheel actuator (RWA), and a second motor 19b, also called a handwheel actuator (HWA). The HWA 19b is configured to provide a torque to the steering wheel 26 for providing haptic feedback to a driver.

SbW is a direct evolution of the EPS system where there is no mechanical coupling between the steering wheel 26 and the steering rack. As seen in FIG. 2, an EPS system may include a single actuator 19 with the sole purpose of providing assist to the driver during steering actions. However, on the SbW system, there are two electric actuators/motors with different functionalities. The electric actuator attached to the steering mechanism 36 in a SbW system is called the roadwheel actuator (RWA) 19a, whereas the actuator on the driver side is known as the handwheel actuator (HWA) 19b. The RWA 19a may provide the same assist function as the actuator 19 in an EPS system. The HWA 19b, on the other hand, acts more as a feedback motor rather than providing assist to the driver. In the absence of the HWA 19b the handwheel on a SbW system would just freewheel because of the absence of any mechanical coupling/friction. The HWA 19b, because of its' functionality, opens a wide array of design-related opportunities.

As used herein, variables with a tilde (˜) above the variable symbol represent an approximation, which may be determined by a mathematical calculation, a lookup table, etc. Variables with a bar above the variable symbol represent a vector quantity. Variables with a superscript star (*) represent commands or desired set point values.

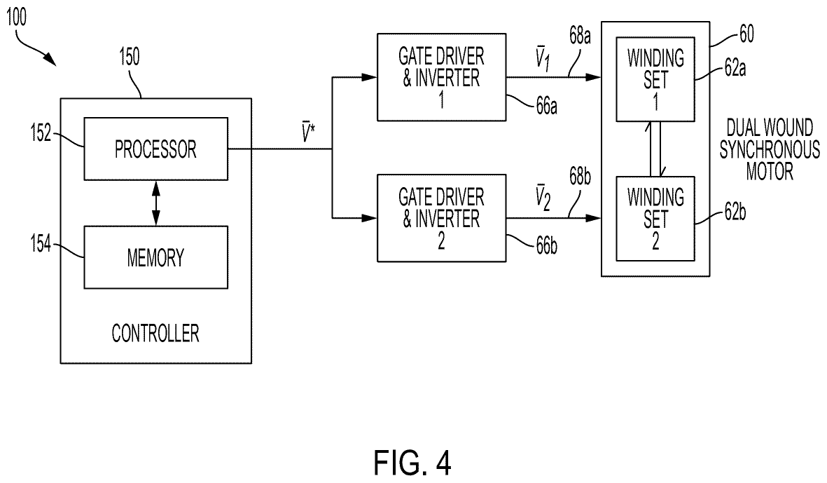

FIG. 4 illustrates an electric motor drive system 100 having a dual wound permanent magnet synchronous motor (DW-PMSM), also called a dual wound synchronous machine (DWSM) or a dual wound motor 60, power converters 66a and 66b (each including a gate driver and a corresponding inverter), and a motor controller 70 (also referred to as a controller). The dual wound motor 60 may be used in any number of applications, such as for the motor 19 in the steering motion control system 24 shown in FIG. 1. The power converters 66a and 66b may include several switching devices, such as field effect transistors (FETs) for switching high current loads and gate driver circuitry for operating the switching devices. The motor controller 70 receives a motor torque command Tₑ* from a motion controller 80, such as, for example, a power steering controller.

The motor controller 70 may generate the voltage command V̅* based on the motor torque command Tₑ* from the motion controller 80, and using any feedforward control technique. For example, the motor controller 70 may include a voltage command generator (not shown) to generate the voltage command V̅* using one or more optimizations and/or to cause the electric motor drive system to satisfy one or more operating constraints, such as constraints on voltage and/or current produced by or supplied to the electric motor drive system. The feedforward voltage control technique may include a technique provided in the present disclosure, although other feedforward control techniques may be used.

The dual wound motor 60 includes a first winding set 62a and a second winding set 62b that is electrically independent of the first winding set 62a. The dual wound motor 60 is capable of generating electromagnetic torque by energizing either or both winding sets 62a, 62b. The two winding sets 62a and 62b may each include three phases and thus, each of the two winding sets 62a, 62b may include three phase windings. Alternatively, each of the winding sets 62a, 62b may include any number of winding phases, such as five or seven phases. In some embodiments, the dual wound motor 60 is a poly-phase permanent magnet synchronous machine (PMSM). Each of the winding sets 62a, 62b may function individually, and the dual wound motor 60 can be operated by energizing either or both of the winding sets 62a, 62b.

The power converters 66a and 66b are configured to supply alternating current (AC) voltages to the winding sets 62a and 62b, respectively. The winding sets 62a, 62b are connected to their respective power converters 66a, 66b through the phase leads 68a and 68b. This configuration may provide for redundancy, allowing the dual wound motor 60 to continue to function even with a total loss or failure of one of the winding sets 62a, 62b, one of the motor leads 68a, 68b, and/or one of the power converters 66a, 66b. The power converters 66a, 66b may be implemented with electrical isolation for additional redundancy.

The dual wound motor 60 includes a first winding set 62a and a second winding set 62b that is electrically independent of the first winding set 62a. The dual wound motor 60 is capable of generating electromagnetic torque by energizing either or both winding sets 62a, 62b. The two winding sets 62a and 62b may each include three phases and thus, each of the two winding sets 62a, 62b may include three phase windings. Alternatively, each of the winding sets 62a, 62b may include any number of winding phases, such as five or seven phases. In some embodiments, the dual wound motor 60 is a poly-phase PMSM. However, the dual wound motor 60 may be any type of synchronous machine, such as a poly-phase wound-field synchronous machine. Additionally, the dual wound motor 60 may have a salient pole configuration or a non-salient pole configuration, depending on the placement of the permanent magnets or field winding on the rotor. Each of the winding sets 62a, 62b may function individually, and the dual wound motor 60 can be operated by energizing either or both of the winding sets 62a, 62b.

The power converters 66a and 66b are configured to supply alternating current (AC) voltages to the winding sets 62a and 62b, respectively. The winding sets 62a, 62b are connected to their respective power converters 66a, 66b through the phase leads 68a and 68b. This configuration may provide for redundancy, allowing the dual wound motor 60 to continue to function even with a total loss or failure of one of the winding sets 62a, 62b, one of the motor leads 68a, 68b, and/or one of the power converters 66a, 66b. The power converters 66a, 66b may be implemented with electrical isolation for additional redundancy.

In some embodiments, the electric motor drive system 100 may include a motor controller, such as controller 150, as is generally illustrated in FIG. 4. The controller 150 generates a voltage command V̅* which may include d-axis and q-axis constituent parts, V_{d}*, V_{q}*, respectively. For example, the controller 150 may generate the voltage command V̅* based on a motor torque command Tₑ*. Each of the power converters 66a, 66b applies an output voltage V̅₁, V̅₂ to the corresponding one of the winding sets 62a, 62b based on the voltage command V̅ *.

The controller 150 may include any suitable controller. The controller 150 may be configured to control, for example, various functions of the vehicle systems described herein. The controller 150 may include a processor 152 and a memory 154. The processor 152 may include any suitable processor, such as those described herein. Additionally, or alternatively, the controller 150 may include any suitable number of processors, in addition to or other than the processor 152. The memory 154 may comprise a single disk or a plurality of disks (e.g., hard drives), and includes a storage management module that manages one or more partitions within the memory 154. In some embodiments, memory 154 may include flash memory, semiconductor (solid state) memory or the like. The memory 154 may include Random Access Memory (RAM), a Read-Only Memory (ROM), or a combination thereof. The memory 154 may include instructions that, when executed by the processor 152, cause the processor 152 to, at least, control various functions of the steering system and/or any other suitable function, including those of the systems and methods described herein.

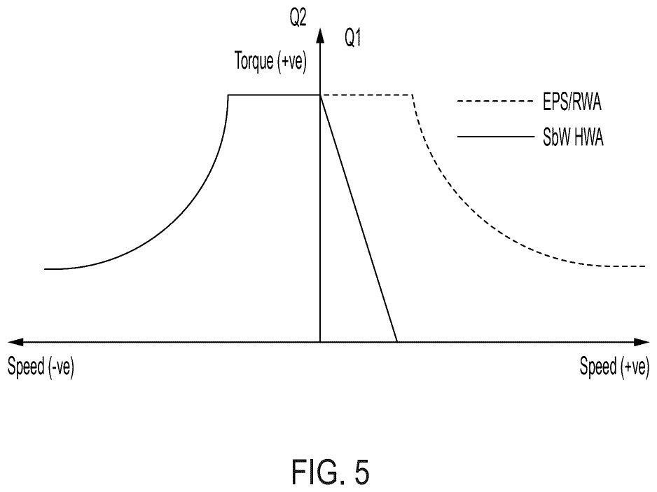

FIG. 5 shows a graph illustrating torque-speed curves of steering system actuators 19, 19a, and 19b. Based on their functionality, the different steering system actuators 19, 19a, 19b have different speed curves. As indicated by the dashed line in FIG. 5, the EPS actuator 19 and the RWA 19a in a SbW each work in the first quadrant (Q1) of the torque-speed curve. The positive direction of speed in Q1 suggests that the actuator acts in the same direction as the driver's handwheel motion and provides assist. However, as indicated by the solid line, the HWA 19b of the SbW system operates mostly in the second quadrant (Q2) of the torque-speed curve. The HWA 19b moves opposite (speed −ve) to the driver's handwheel motion and provides feedback to the driver. This feedback may be necessary to provide generic steering feel and road condition feedback to the driver. Additionally, some low-speed assist (Q1 operation) might also be required from the HWA 19b, as seen in FIG. 5.

The HWA 19b may include an electric motor coupled apply torque to the steering wheel 26 configurations, such as a Worm gear drive, Belt drive, and/or a Direct drive. For the worm gear and belt driven cases, low torque of about 3 Newton meters (Nm) and high speed of about 3000 revolutions per minute (RPM). PMSMs can be used as the actuator. Both surface mounted PMSM (SPMSM) and interior PMSM (IPMSM) topologies can be used for such HWA architectures. Moreover, because of their similarity (in terms of torque speed ranges) a significant number of components can be transferred directly from column EPS (CEPS) systems to worm gear or belt driven SbW handwheel systems.

Based on their functionality, the torque speed curves of the different actuators used in steering systems also changes. As shown in FIG. 5, the EPS actuator and the RWA in a SbW system, each work in the first quadrant (Q1) of the torque-speed curve. The positive direction of speed in Q1 suggests that the actuator acts in the same direction as the driver's handwheel motion and provides assist. However, the SbW HWA operates mostly in the second quadrant (Q2) of the torque speed curve. The HWA moves opposite (speed-ve) to the driver's handwheel motion and provides feedback to the driver. This feedback is necessary to provide generic steering feel and road condition feedback to the driver. Moreover, some low-speed assist (Q1 operation) might also be required from the HWA, as seen in FIG. 5. The very different operating domains of the EPS/RWA and the HWA motivates design exploration for HWA technology.

The HWA 19b may include an electric motor coupled apply torque to the steering wheel 26 configurations, such as a Worm gear drive, Belt drive, and/or a Direct drive. For the worm gear and belt driven cases, low torque (˜3 Nm) and high speed (˜3000 rpm) PMSMs can be used as the actuator. Both surface mounted PMSM (SPMSM) and interior PMSM (IPMSM) topologies can be used for such HWA architectures. Moreover, because of their similarity (in terms of torque speed ranges) a significant number of components can be transferred directly from column EPS (CEPS) systems to worm gear or belt driven SbW handwheel systems. For the direct drive case, high torque (˜30 Nm for egress/ingress) and low speed (˜200-300 rpm) actuators are required. The number of mechanical components decrease for the direct drive architecture, which in turn has the potential to reduce cost and weight. Moreover, a reduction in weight is directly linked to range efficiency or mileage (miles/gallon) increment. However, traditional PMSMs need to be redesigned for the high torque and low speed output requirement of the direct drive architecture.

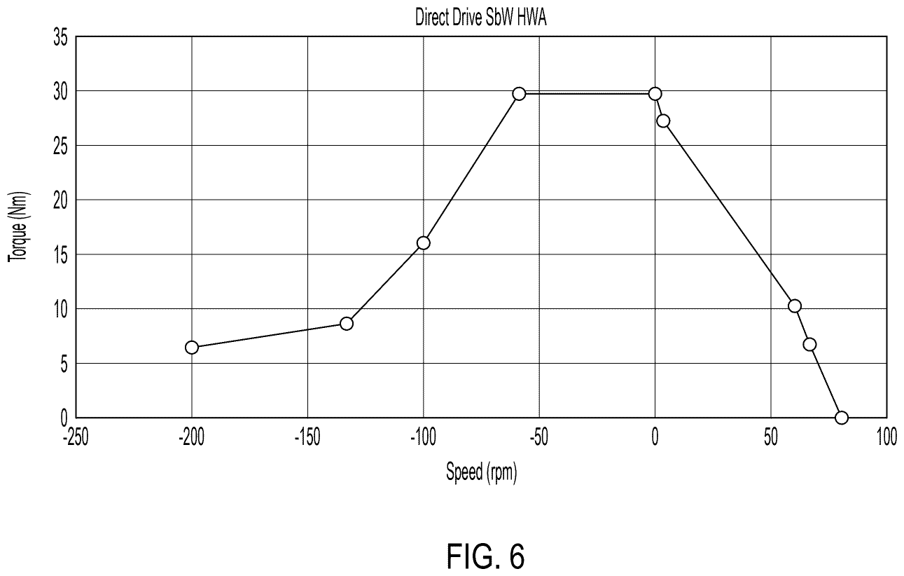

FIG. 6 shows a graph illustrating torque-speed curves of the HWA 19b in a SbW steering system, with a direct drive configuration (1:1 gear ratio). As shown, the HWA 19b generally operates with a speed of between −200 and +80 revolutions per minute (RPM), and produces a torque of between 0 and about 30 Newton meters (Nm). Transverse flux machines have the potential to perform in this low-speed high torque direct drive application.

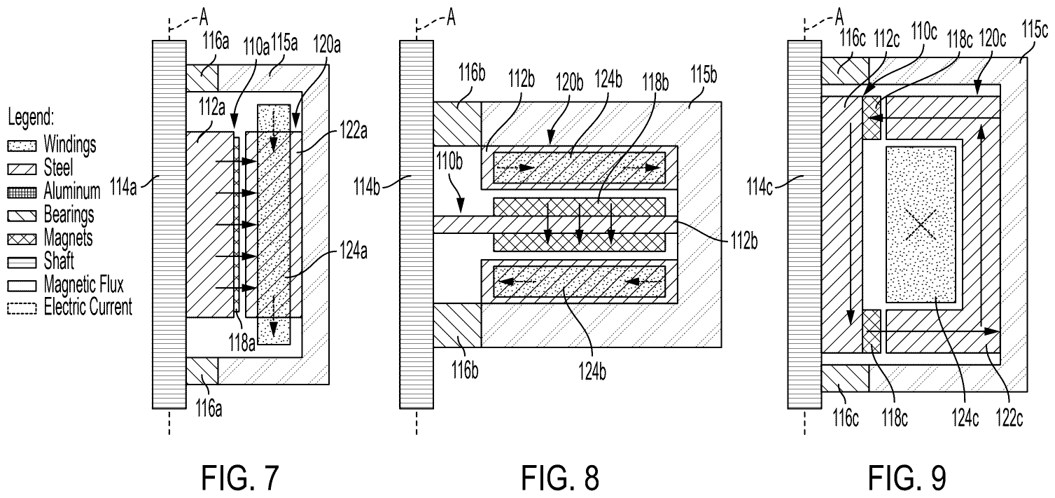

FIG. 7 shows a cross-sectional diagram of a radial flux machine (RFM). FIG. 8 shows a cross-sectional diagram of an axial flux machine (AFM). FIG. 9 shows a cross-sectional diagram of a transverse flux machine (TFM). Each of the RFM, AFM, and TFM devices includes a shaft configured to rotate about an axis A. Classification between the RFM, AFM, and TFM configurations may be made based on direction of magnetic flux.

The RFM of FIG. 7 includes a first rotor 110a having a first rotor core 112a attached to rotate with a first shaft 114a about an axis A. The first rotor 110a is located within a first housing 115a and the first shaft 114a extends through and out of the first housing 115a and is supported by a pair of first bearings 116a. A set of first permanent magnets 118a is attached to the first rotor core 112a and produces a magnetic flux that extends radially outwardly. The RFM of FIG. 7 also includes a first stator 120a having a first stator core 122a with a set of first windings 124a extending therethrough and carrying electric current in an axial direction, parallel to the axis A, and perpendicular to the magnetic flux.

The AFM of FIG. 8 includes a second rotor 110b having a second rotor core 112b attached to rotate with a second shaft 114b about an axis A. The second rotor 110b is located within a second housing 115b and the second shaft 114b extends through and out of the second housing 115b and is supported by a pair of second bearings 116b. A set of second permanent magnets 118b is attached to the second rotor core 112b and produces a magnetic flux that extends in an axial direction, parallel to the axis A. The AFM of FIG. 8 also includes a second stator 120b having a second stator core 122b with a set of second windings 124b extending therethrough and carrying electric current in a radial direction, perpendicular to the axis A, and perpendicular to the magnetic flux.

The TFM of FIG. 9 includes a third rotor 110c having a third rotor core 112c attached to rotate with a third shaft 114c about an axis A. The third rotor 110c is located within a third housing 115c and the third shaft 114c extends through and out of the third housing 115c and is supported by a pair of third bearings 116c. A set of third permanent magnets 118c is attached to the third rotor core 112c and produces a magnetic flux that extends radially inwardly at a first location, axially through the third rotor core 112c, and radially outwardly at a second location spaced apart axially apart from the first location. The TFM of FIG. 9 also includes a third stator 120c having a third stator core 122c with a set of third windings 124c extending therethrough and carrying electric current in an circumferential direction, perpendicular to the axis A, and perpendicular to the magnetic flux. As shown, the third stator core 122c defines a U-shape, with open ends aligned with the third permanent magnets 118c at the first and second locations for providing, with the third rotor core 112c, a closed rectangular path of the magnetic flux.

FIGS. 7-9 show the flux direction in the three machine topologies. For the RFM, the flux moves radially in the airgap, whereas for the AFM the flux moves axially from the stator to rotor and vice versa. However, as seen in FIG. 9 for the TFM, the flux moves both in the radial and the axial directions. Even though several topologies of TFM can be identified from the literature, 3D (radial and axial) flux paths are a common feature across different topologies. TFMs are known for their higher volumetric and gravimetric power densities compared to radial flux machines. AFMs and TFMs are known to have comparable power densities. However, the simplicity of the ring windings in a TFM has the potential to case manufacturing process and save cost.

As shown in FIG. 6, the magnetic flux in the RFM extends primarily in a radial direction, perpendicularly to the axis A. As shown in FIG. 7, the magnetic flux in the AFM extends primarily in an axial direction, parallel to the axis A. As shown in FIG. 8 the magnetic flux in the TFM defines a closed loop path, with portions extending in a radial direction, perpendicularly to the axis A, and with other portions extending in an axial direction, parallel to the axis A. The RFM, AFM, and TFM configurations may each provide different volumetric and gravimetric power densities. The TFM configuration may be especially well suited for low speed and high torque operation.

The present disclosure provides a Transverse flux machine (TFM) topology for a direct drive SbW HWA architecture. Transverse flux machines have the potential to provide significant power density advantages over the traditional radial flux machines in the low-speed high torque region of operation of a direct drive SbW HWA. Generic design guidelines of TFMs are given below. Traditional RFMs can be laminated in the radial X-Y plane to accommodate their 2D flux paths and reduce eddy current losses at high frequencies of operation. AFMs can be laminated as well in the axial X-Z plane to assist the axial travel of the flux from the stator to rotor and vice versa. However, As seen in FIG. 3(c), for a TFM the flux moves in both radial and axial direction. If a TFM were to be laminated, it would need to have both X-Y and X-Z direction laminations depending on the core location and intended direction of flux travel. This would severely complicate the manufacturing process of the TFM. In order to avoid complications and ensure 3D flux travel in the TFM cores, soft magnetic core (SMC) material is chosen here. SMC is insulated iron particles compacted into the shape of the cores. Electrical insulation among the iron particles of a compacted SMC core significantly reduces the eddy current loss at higher frequencies of operation. The conclusions drawn in this document are equally applicable to a TFM made of laminated steel.

Several TFM topologies are provided, with different performance areas where they excel. TFM designs generally indicate a trend towards increasing volumetric torque density. However, for steering applications, the actuator may be subjected to much stricter constraints of torque ripple, cogging torque, friction loss and so on. Additionally, manufacturing case may be an important criterion.

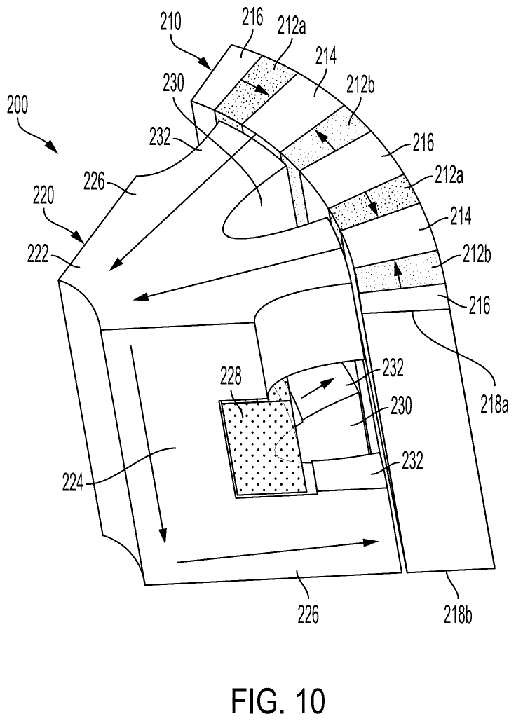

FIG. 10 shows a perspective fragmentary view of a TFM with a flux-concentrating outer rotor and a single-piece stator. Reducing the number of pieces in the TFM may simplify the manufacturing process. Moreover, flux concentrating rotor structures display higher power densities and reduced magnet weight compared to other rotor topologies. Furthermore, the ring winding structure of the TFMs simplifies the winding process compared to needle wound radial flux machines. The TFM design shown in FIG. 10 may be advantageous for case of manufacturing provided by the topology. It can be stacked axially and space shifted circumferentially to form a multiphase machine.

As shown, FIG. 10 presents a first TFM 200 having an external rotor configuration, with a fourth rotor 210 that is configured to rotate about an axis, with the rotor extending annularly about a first internal stator assembly 220. FIG. 10 shows a 45-degree segment of the first TFM 200, with labels indicating magnetic flux. However, the complete first TFM 200 would include eight of such segments. The fourth rotor 210 includes a plurality of pairs of fourth permanent magnets 212a, 212b arranged at regular angular intervals and configured to produce magnetic flux in a circumferential direction therebetween. The fourth rotor 210 also includes a plurality of first flux concentrating cores 214 located between the fourth permanent magnets 212a, 212b of each of the pairs of fourth permanent magnets 212a, 212b and configured to conduct the magnetic flux therebetween. The fourth rotor 210 also includes a plurality of first flux diverging cores 216, each located between adjacent pairs of the fourth permanent magnets 212a, 212b. The fourth rotor 210 has a tubular shape and extends between a first axial end 218a and a second axial end 218b.

As also shown in FIG. 10, the first internal stator assembly 220 includes an internal stator core 222 having a U-shaped cross-section with an inner cylindrical portion 224 and a pair of arms 226 extending radially outwardly from each end of the inner cylindrical portion 224 and toward the fourth rotor 210. A winding 228 extends in circumferential direction through the center of the U-shaped cross-section of the internal stator core 222 and conducts electrical current in the circumferential direction.

As shown, each arm 226 of the internal stator core 222 includes an arc-shaped recess 230 to define two radial-extending protrusions 232 that are angularly spaced apart to align with adjacent ones of the first flux concentrating cores 214 and the first flux diverging cores 216. In this way, magnetic flux is conducted from each of the first flux concentrating cores 214 adjacent the first axial end 218, across an airgap and into the radial-extending protrusions 232 of the internal stator core 222 adjacent thereto. The magnetic flux is directed into the inner cylindrical portion 224 of the internal stator core 222 where it continues in an axial direction. The magnetic flux is also directed out of the inner cylindrical portion 224 of the internal stator core 222 and radially outwardly through the arms 226 of the internal stator core 222 adjacent to the second axial end 218b, where it crosses the airgap into a corresponding ones of the first flux diverging cores 216. The magnetic flux continues through corresponding ones of the fourth permanent magnets 212a, 212b and then back into the first flux concentrating cores 214, thereby completing a closed path.

A TFM may be particularly well suited for direct drive low speed operation. The TFM may include a modular, spatially shifted three-phase stator architecture. The TFM may include a simple ring winding with inner stator topology. The TFM may provide a relatively low phase resistance, independent of number of stator slots and rotor poles. The TFM may include an outer rotor structure with high volumetric and gravimetric torque density. The TFM may be relatively easily and efficiently manufactured and may provide suitable performance for a variety of applications in an EPS and/or SbW system.

The phase resistance and the coil cross-section in a ring wound TFM are independent of the number of poles which enables higher torque density in TFMs compared to RFMs. Moreover, for some applications, such as a direct drive HWA in a SbW system, the operating speed is relatively low. This indicates that the fundamental electrical frequency of operation will be within a reasonable range, even if a higher pole number TFM is chosen. For example, for a 12 slot 8 pole SbW HWA with a gear ratio of 11:1, the fundamental frequency is 166.67 Hz at 2500 motor rpm. On the other hand, for a TFM with 100 poles and a direct drive structure, the fundamental frequency is 189.39 Hz at 227.27 motor rpm. The limiting number of poles (Pmax) for a TFM can be calculated using equation (1):

$${n}_{limit} = \frac{120 {f}_{e , max}}{{P}_{max}} \qquad ( 1 )$$

where nₗᵢₘᵢₜ is the maximum motor speed in rpm, f_{e,max} is the maximum fundamental electrical frequency that can be handled by the motor drive.

Moreover, despite higher number of poles in TFMs the phase resistance does not increase which can offer reduced copper loss and thus improve efficiency and thermal performance.

### Inner Rotor/Outer Rotor Topology

The general sizing equation of a TFM can be written as in equation (2):

$${P}_{R} = \frac{m}{2} \frac{1}{1 + {K}_{phi}} {K}_{e} {K}_{i} {K}_{p} {K}_{L} η {B}_{g} A \frac{f}{p} {λ}_{o}^{2} {D}_{o}^{2} {L}_{e} \qquad ( 2 )$$

where P_{R} is the rated output power, Kₚₕᵢ is the ratio of electrical loading on rotor and stator (Kₚₕᵢ may be equal to zero), m is the number of phases, Kₑ is the BEMF factor incorporating the winding distribution factor Kw and the per unit portion of the total air gap area spanned by the salient poles of the machine (if any), Kᵢ is the current waveform factor, Kₚ is the electrical power waveform factor, K_{L} is the ratio of the stack length Le vs. the diameter of the airgap surface D_{g}, n is the machine efficiency, B_{g} is the airgap flux density, A is the total electrical loading, f is the driver frequency, p is the number of pole pairs, Dₒ is the outer diameter of the machine and λₒ is the ratio between D_{g} and Dₒ.

As evident from equation (2), the rated power and thus the torque output of the TFM is directly proportional to the square of the outer diameter of the machine Dₒ. Substituting D_{g}/Dₒ in place of λₒ it can be shown from (2) that the output power directly relates to the square of Dg. Going from an inner rotor TFM to an outer rotor TFM, the diameter of the airgap surface can be increased with better space utilization. This leads to higher volumetric torque density in outer rotor TFMs. Moreover, in outer rotor TFMs the winding process is comparatively simpler. Both outer and inner rotor TFMs are systematically optimized in accordance with the present disclosure.

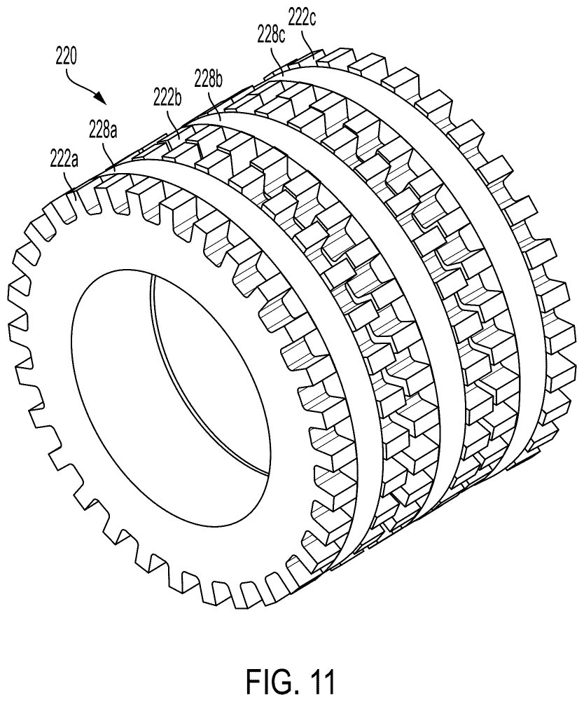

FIG. 11 shows a perspective view of the first internal stator assembly 220 for an external rotor TFM, which is configured to have the rotor (not shown) disposed annularly thereabout. The first internal stator assembly 220 includes three internal stator cores 222a, 222b, 222c, including an A-phase internal stator core 222a, a B-phase internal stator core 222b, and a C-phase internal stator core 222c. The three internal stator cores 222a, 222b, 222c each have similar or identical ring shapes that are stacked axially and shifted circumferentially from one-another. Each of the three internal stator cores 222a, 222b, 222c of the first internal stator assembly 220 contains a corresponding winding 224a, 224b, 224c of a corresponding phase, and which extends circumferentially therethrough. Each of the three internal stator cores 222a, 222b, 222c of the first internal stator assembly 220 also defines a plurality of radial-extending protrusions at regular angular intervals and extending radially outwardly.

The stacked assembly of the TFM stator leads to inherent asymmetry issues. As shown in FIG. 11, the B-phase internal stator core 222b is stacked between the A-phase internal stator core 222a and the C-phase internal stator core 222c in a 3-phase TFM. The A-phase internal stator core 222a and the C-phase internal stator core 222c may each be called exterior cores because of their location adjacent to an axial end of the stator assembly. The B-phase internal stator core 222b may be called an interior stator core, because of its location spaced apart from the axial end of the stator assembly.

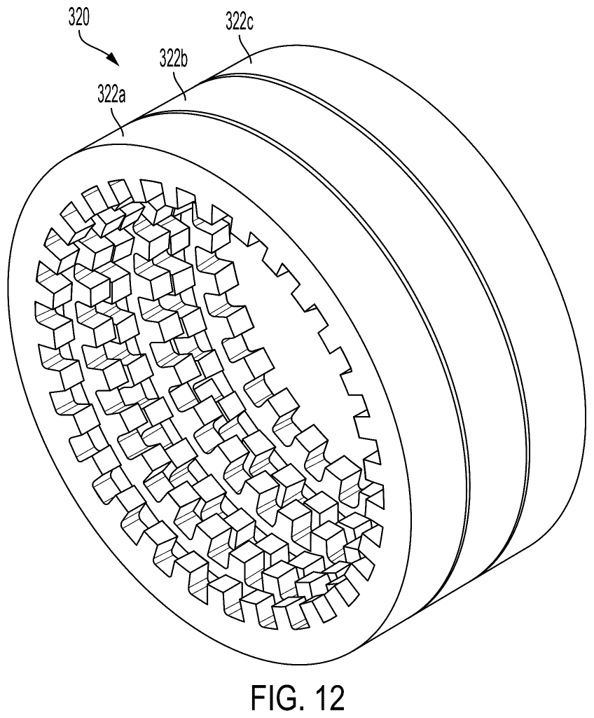

FIG. 12 shows a perspective view of an external stator assembly 320 for an internal rotor TFM, which is configured to be disposed annularly about a rotor (not shown). external stator assembly 320 includes three external stator cores 322a, 322b, 322c, including an A-phase external stator core 322a, a B-phase external stator core 322b, and a C-phase external stator core 322c. The three external stator cores 322a, 322b, 322c each have similar or identical ring shapes that are stacked axially and shifted circumferentially from one-another. Each of the three external stator cores 322a, 322b, 322c of the external stator assembly 320 may contain a corresponding winding (not shown in FIG. 12) of a corresponding phase, and extending circumferentially therethrough. Each of the three external stator cores 322a, 322b, 322c of the external stator assembly 320 also defines a plurality of radial-extending protrusions at regular angular intervals and extending radially inwardly.

Several different factors may affect the design of a TFM. Such design factors may include: topology selection and manufacturing challenges; material selection; number of poles; Inner/Outer rotor (i.e. internal rotor or external rotor configuration); multiphysics performance; and 3-dimensional (3D) simulations, which may be computationally expensive.

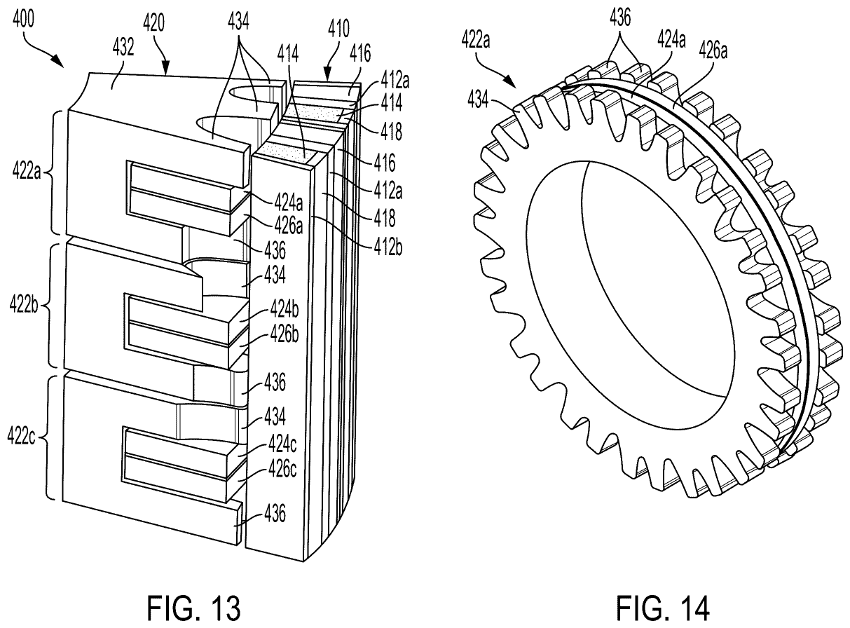

FIG. 13 shows a perspective fragmentary view of a second TFM 400 having a gear-style configuration. The second TFM 400 includes a fifth rotor 410, which may be similar or identical to the fourth rotor 210, except for differences described herein. The second TFM 400 also includes a second internal stator assembly 420, which may be similar or identical to the first internal stator assembly 220, except for differences described herein.

The fifth rotor 410 includes a plurality of pairs of fifth permanent magnets 412a, 412b arranged at regular angular intervals and configured to produce magnetic flux in a circumferential direction therebetween. The fifth rotor 410 also includes a plurality of second flux concentrating cores 414 located between the fifth permanent magnets 412a, 412b of each of the pairs of fifth permanent magnets 412a, 412b and configured to conduct the magnetic flux therebetween. As shown, the magnetization of the fifth permanent magnets 412a, 412b are each directed inwardly, into a corresponding one of the second flux concentrating cores 414. The fifth rotor 410 also includes a plurality of second flux diverging cores 416, each located between adjacent pairs of the fifth permanent magnets 412a, 412b.

The fifth rotor 410 also includes a non-magnetic portion 418 of non-magnetic material located between the fifth permanent magnets 412a, 412b of each of the pairs of fifth permanent magnets 412a, 412b and adjacent to each of the second flux concentrating cores 414. The second non-magnetic portion 418 may include a non-magnetic solid material, such as Aluminum or epoxy. Alternatively or additionally, the non-magnetic portion 418 may include space filled with ambient air. The non-magnetic portions 418 are each located opposite from the second internal stator assembly 420, with a corresponding one of the second flux concentrating cores 414 disposed between each of the non-magnetic portions 418 and the second internal stator assembly 420.

As also shown in FIG. 13, the second internal stator assembly 420 includes three gear-style stator cores 422a, 422b, 422c, including an a-phase gear-style stator core 422a, a b-phase gear-style stator core 422b, and a c-phase gear-style stator core 422c. The three gear-style stator cores 422a, 422b, 422c each have similar or identical ring shapes that are stacked axially and shifted circumferentially from one-another. FIG. 14 shows a perspective view of the a-phase gear-style stator core 422a, with a dual-wound configuration.

Referring back to FIG. 13, each of the three gear-style stator cores 422a, 422b, 422c has a gear-shape and includes a first internal stator core 432 having a generally tubular shape. Each of the three gear-style stator cores 422a, 422b, 422c also includes a first plurality of protrusions 434 that extend radially outwardly from the first internal stator core 432, toward the fifth rotor 410, and which are spaced apart at regular angular intervals. Each of the three gear-style stator cores 422a, 422b, 422c also includes a second plurality of protrusions 436 that extend radially outwardly from the first internal stator core 432, toward the fifth rotor 410, and which are spaced apart at regular angular intervals. The second plurality of protrusions 436 are axially spaced apart from the first plurality of protrusions 434 and are circumferentially offset therefrom.

Each of the three gear-style stator cores 422a, 422b, 422c has a dual-wound configuration, although the principles of the present disclosure may be applicable with a single-winding configuration or a greater number of stator windings in each of the stator cores. The a-phase gear-style stator core 422a includes two a-phase stator windings 424a, 426a having a ring shape and disposed substantially entirely between the first plurality of protrusions 434 and the second plurality of protrusions 436. For example, the a-phase stator windings 424a, 426a may be entirely sandwiched axially between the two sets of protrusions 434, 436, with the possible exception of a small segment of wire for connection to external circuitry. The first plurality of protrusions 434 and the second plurality of protrusions 436 may be described as flanking the a-phase stator windings 424a, 426a, being lined-up on each axial side thereof. The b-phase gear-style stator core 422b and the c-phase gear-style stator core 422c each include a similar configuration of two corresponding stator windings 424b, 426b, and 424c, 426c, respectively.

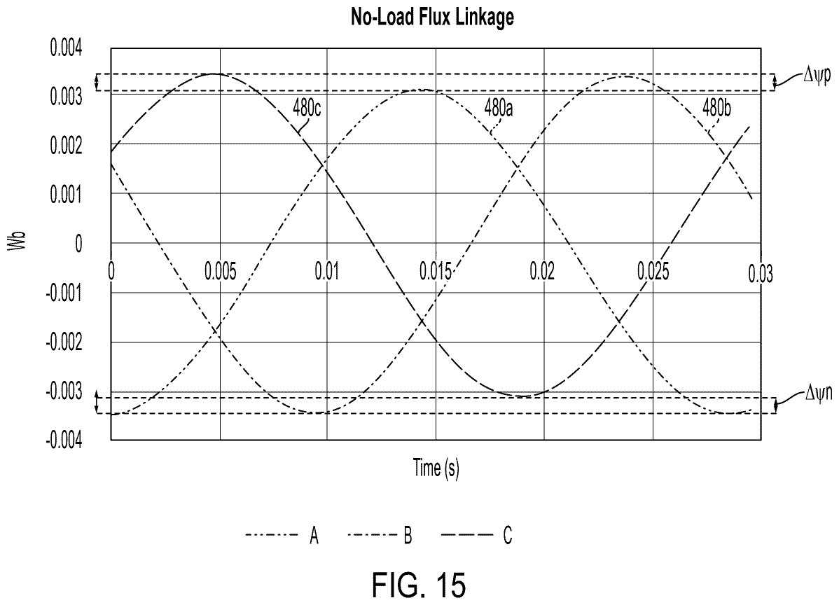

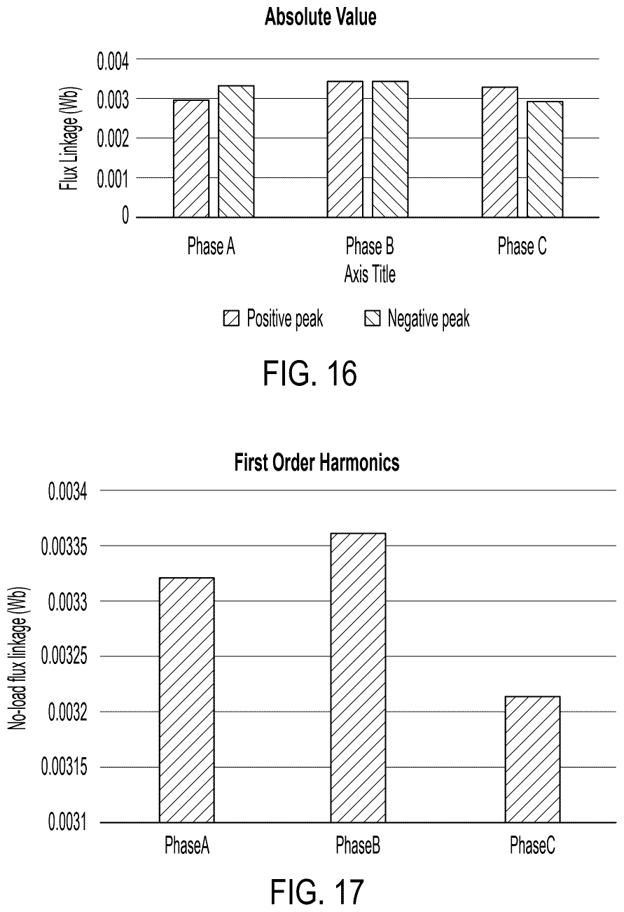

FIG. 15 shows a graph illustrating flux linkage imbalance between phases of a three-phase TFM with a gear-style stator, such as the second TFM 400, and during no-load operation. FIG. 15 includes a first plot 480a showing A-phase flux linkage, a second plot 480b showing the B-phase flux linkage, and a third plot 480c showing the C-phase flux linkage. As shown in FIG. 15, the peak values of the no-load flux linkage are different for the different phases. Phase B has greater flux linkage compared to Phase A and Phase C. The differences in the positive and negative flux linkages are labeled Δψp and Δωn, respectively. FIG. 16 shows a graph illustrating peak absolute values of the positive and negative flux linkages in the three-phase TFM with the gear-style stator and during no-load operation, and FIG. 17 shows a graph illustrating first order harmonics of flux linkage in the three-phase TFM with the gear-style stator and during no-load operation. As shown, the absolute values of the positive and the negative flux linkages are also unequal, which can cause unbalance in the machine. Also, as shown in FIG. 17, the first order harmonics of the no-load flux linkage are also unequal. This asymmetry in the flux linkages may cause second order torque ripple harmonics in the machine. In order to compensate for these unequal flux linkages and their corresponding and detrimental effects, the present disclosure includes a rotors with an axial length that is different from the axial length of the stator.

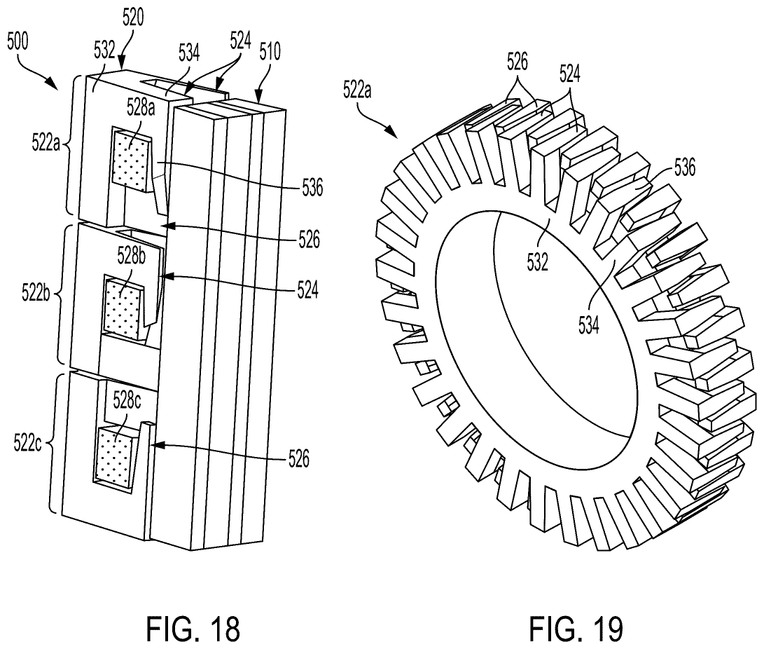

FIG. 18 shows a perspective fragmentary view of a third TFM 500 with a claw pole configuration. The third TFM 500 includes a sixth rotor 510, which may be similar or identical to the fourth rotor 210. Alternatively, the third TFM 500 may use a different rotor configuration, such as an internal rotor or a rotor that is similar or identical to the fifth rotor 410 of the second TFM 400. The third TFM 500 also includes a third internal stator assembly 520, which may be similar or identical to the first internal stator assembly 220, except for differences described herein.

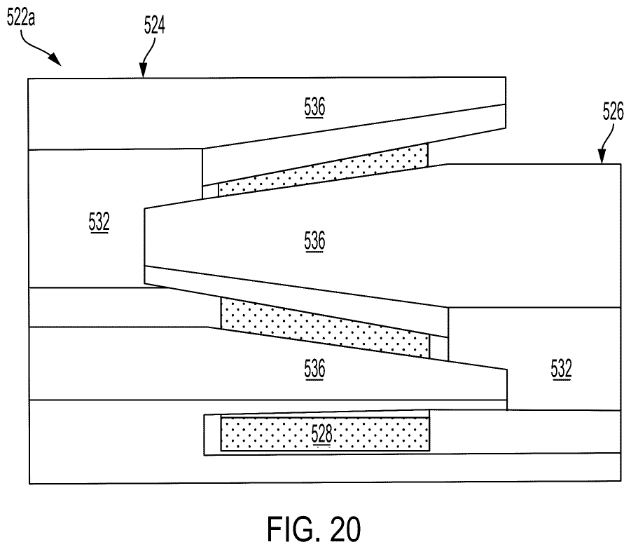

As also shown in FIG. 18, the second internal stator assembly 420 includes three claw pole stator cores 522a, 522b, 522c, including an a-phase claw pole stator core 522a, a b-phase claw pole stator core 522b, and a c-phase claw pole stator core 522c. The three claw pole stator cores 522a, 522b, 522c each have similar or identical ring shapes that are stacked axially and shifted circumferentially from one-another. FIG. 19 shows a perspective view of the a-phase claw pole stator core 522a, with a single-wound configuration. FIG. 20 shows a fragmentary view of the a-phase claw pole stator core 522a.

Each of the three claw pole stator cores 522a, 522b, 522c has a single-wound configuration, although the principles of the present disclosure may be applicable to a configuration with two or more windings in each of the stator cores. An a-phase stator winding 528a having a ring shape is disposed within and surrounded by the a-phase claw pole stator core 522a. A similar b-phase stator winding 528b and c-phase stator winding 528c are disposed within and surrounded by the b-phase claw pole stator core 522b and the c-phase claw pole stator core 522c, respectively.

Referring back to FIG. 18, each of the three claw pole stator cores 522a, 522b, 522c has a claw-pole shape and includes a second internal stator core 532 having a generally tubular shape. Each of the three claw pole stator cores 522a, 522b, 522c also includes a first plurality of teeth 524 spaced apart at regular angular intervals and which extend radially outwardly from the second internal stator core 532, toward the sixth rotor 510, and wrapping over a corresponding one of the stator windings 528a, 528b, 528c in a first axial direction. Each of the three claw pole stator cores 522a, 522b, 522c also includes a second plurality of teeth 526. The second plurality of teeth 526 are spaced apart at regular angular intervals and extend radially outwardly from the second internal stator core 532, toward the sixth rotor 510. The second plurality of teeth 526 each also wrap over a corresponding one of the stator windings 528a, 528b, 528c in a second axial direction opposite the first axial direction. In other words, and as best shown in FIG. 19, the second plurality of teeth 526 are circumferentially offset from the first plurality of teeth 524 in an interlocking pattern. Each of the teeth 524, 526 includes a radial portion 534 having a rectangular cross-section that extends radially outwardly from the second internal stator core 532, toward the sixth rotor 510. Each of the teeth 524, 526 also includes an axial portion 536 that extends in an axial direction from a corresponding one of the radial portions 534 at an end thereof opposite from the second internal stator core 532. Each of the axial portions 536 have a generally trapezoidal shape that tapers down away from the corresponding one of the radial portions 534. However, some or all of the teeth 524, 526 may have a different shape.

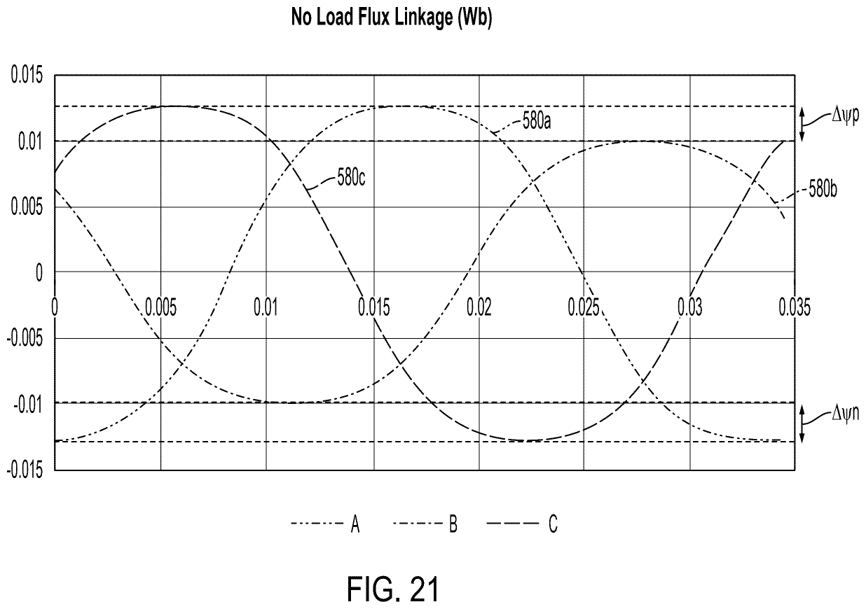

FIG. 21 shows a graph illustrating flux linkage imbalance between phases of a three-phase TFM with a claw pole-style stator and during no-load operation. FIG. 21 includes a first plot 580a showing A-phase flux linkage, a second plot 580b showing the B-phase flux linkage, and a third plot 580c showing the C-phase flux linkage. As shown in FIG. 21, the peak values of the no-load flux linkage are different for the different phases. Phase B has a lower flux linkage compared to Phase A and Phase C. The differences in the positive and negative flux linkages are labeled Δψp and Δψn, respectively. As a result, a second order torque ripple order will be generated in the machine.

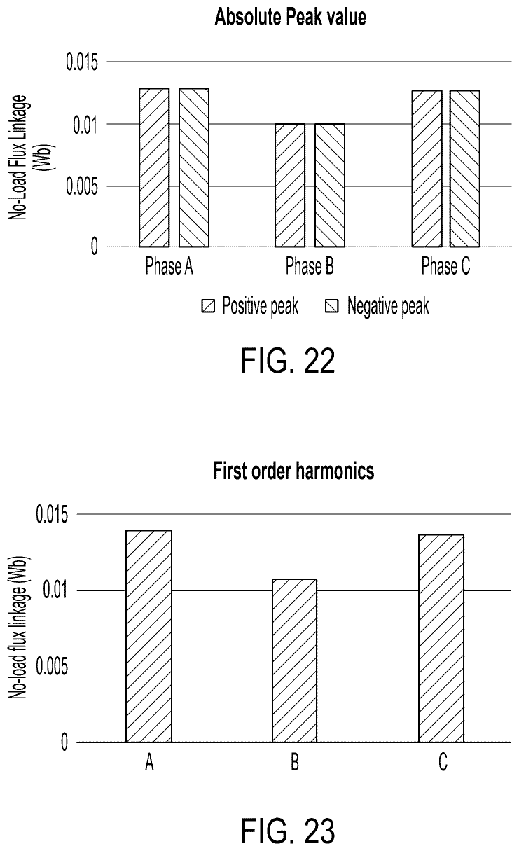

FIG. 22 shows a graph illustrating peak absolute values of the positive and negative flux linkages in the three-phase TFM with the gear claw pole-style and during no-load operation. FIG. 23 shows a graph illustrating first order harmonics of flux linkage in the three-phase TFM with the claw pole-style stator and during no-load operation. As shown in FIG. 23, the first order harmonics of the no-load flux linkage are unequal. This asymmetry in the flux linkages may cause second order torque ripple harmonics in the machine. In order to compensate for these unequal flux linkages and their corresponding and detrimental effects, the present disclosure provides TFM designs with rotors having an axial length that is different from the axial length of the stator.

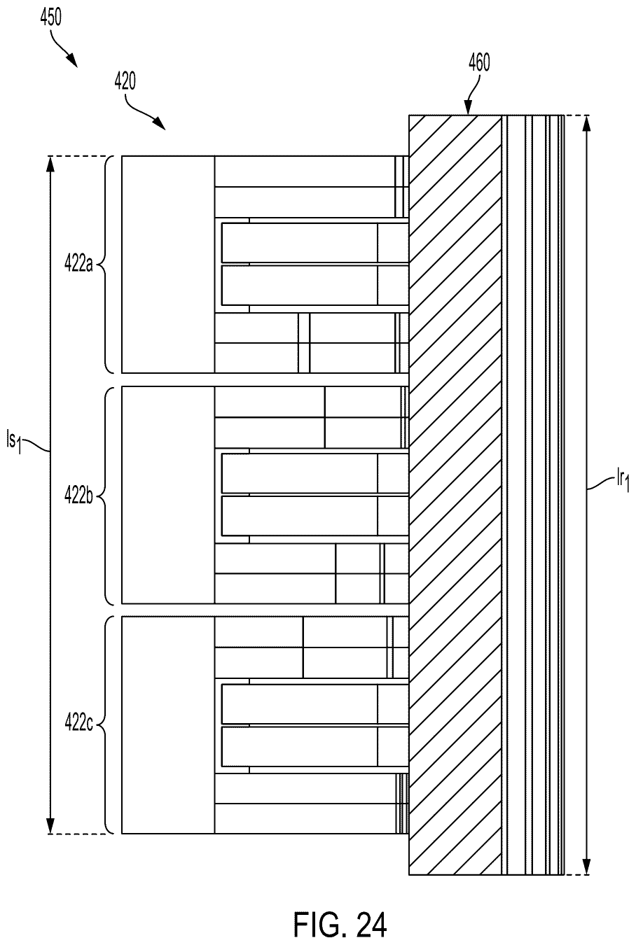

FIG. 24 shows a cut-away fragmentary side view of a fourth TFM 450 with a gear-style stator, in accordance with the present disclosure. The fourth TFM 450 is configured as a three-phase machine and is similar to the second TFM 400 of FIG. 13. However, the fourth TFM 450 may have a different number of phases by including a different number of the gear-style stator cores 422a, 422b, 422c. The fourth TFM 450 includes the second internal stator assembly 420 that defines a first stator length lₛ₁ in an axial direction. The fourth TFM 450 also includes a seventh rotor 460, which may be similar or identical to the fifth rotor 410 and/or the sixth rotor 510. As shown on FIG. 24, the seventh rotor 460 defines a first rotor length lᵣ₁ in an axial direction, and which is longer than the first stator length lₛ₁. In other words, the fourth TFM 450 is configured as a three-phase machine with the gear-style stator defining the first stator length lₛ₁ in an axial direction and with a rotor having a first rotor length lᵣ₁ that is longer than the first stator length lₛ₁.

Increasing the rotor length in the end-regions will help to mitigate the end-region leakages and will make the three-phase flux distribution more even. The longer seventh rotor 460 of the fourth TFM 450 is configured to compensate for the imbalance in the flux linkages of the second TFM 400. To prove the concept, different cases are considered as shown in table 1, below.

TABLE 1

| Design | Rotor Axial | Stator Axial | Rotor Length | | Rotor Length |
|---|---|---|---|---|---|
| Name | Length | Length | Difference (mm) | | Difference (%) |
| Case 0 | 49 mm | 50 mm | −1 | mm | −2% |
| Case 1 | 50 mm | 50 mm | 0 | mm | 0% |
| Case 2 | 51 mm | 50 mm | +1 | mm | 2% |
| Case 3 | 52 mm | 50 mm | +2 | mm | 4% |
| Case 4 | 53 mm | 50 mm | +3 | mm | 6% |
| Case 5 | 54 mm | 50 mm | +4 | mm | 8% |
| Case 6 | 55 mm | 50 mm | +5 | mm | 10% |
| Case 7 | 56 mm | 50 mm | +6 | mm | 12% |

The torque ripple harmonics were measured for the gear-shape stator TFM with varying rotor lengths indicated in Table 1. Rotors with an axial length greater than an axial length of the stator were found to reduce the second order harmonics. The Case 3 design, with the rotor having a first rotor length lᵣ₁ that is 4% longer than the first stator length lₛ₁ of the stator was found to provide a maximum improvement in reducing the second order harmonics.

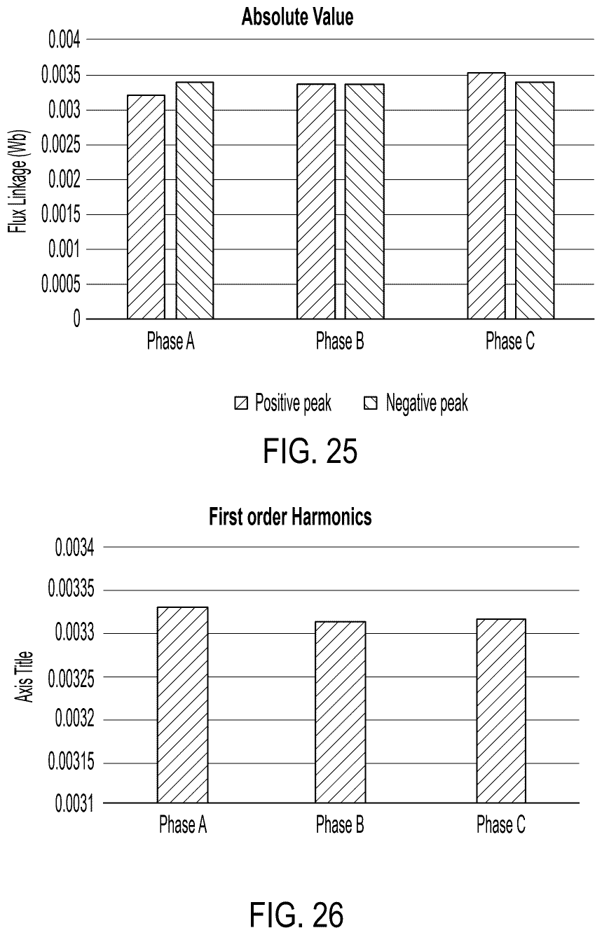

FIG. 25 shows a graph illustrating positive and negative peak values of flux linkage in the fourth TFM 450, with the gear-style stator and the elongated rotor with the Case 3 configuration, during no-load operation. As shown in FIG. 25, the no-load flux linkage has become almost equal for the case 3 condition, which may provide a corresponding reduction in the second order torque ripple. FIG. 26 shows a graph illustrating first order harmonics of flux linkage in the fourth TFM 450, with the gear-style stator and the elongated rotor with the Case 3 configuration, during no-load operation. The fundamental harmonics of the no-load flux linkage is also more equal for case 3, as shown by FIG. 26.

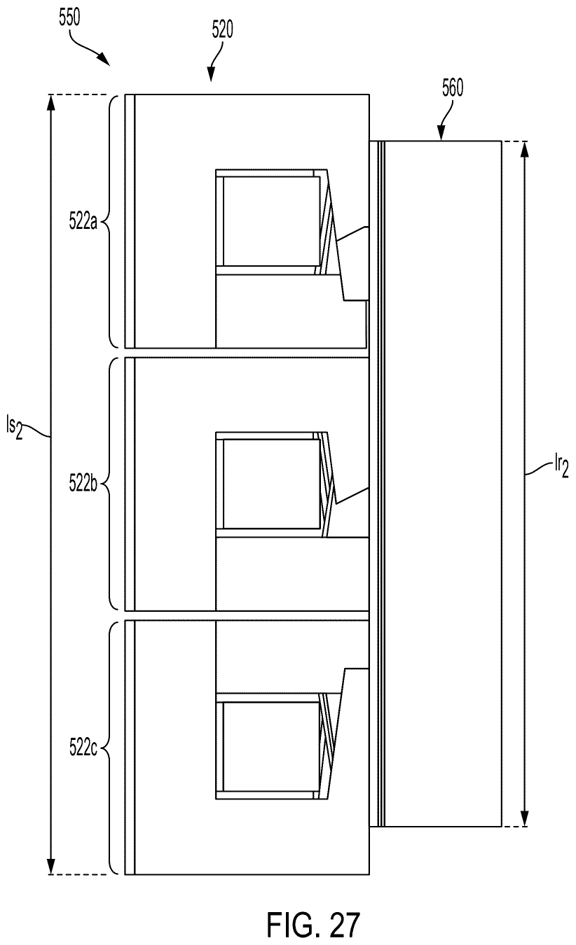

FIG. 27 shows a cut-away fragmentary side view of a fifth TFM 550 with a claw-pole style stator, in accordance with the present disclosure. The fifth TFM 550 is configured as a three-phase machine and is similar to the third TFM 500 of FIG. 18. However, the fifth TFM 550 may have a different number of phases by including a different number of the three claw pole stator cores 522a, 522b, 522c. The fifth TFM 550 includes the third internal stator assembly 520 that defines a second stator length lₛ₂ in an axial direction. The fifth TFM 550 also includes an eighth rotor 560, which may be similar or identical to the fifth rotor 410 and/or the sixth rotor 510. As shown on FIG. 27, the eighth rotor 560 defines a second rotor length lᵣ₂ in an axial direction, and which is shorter than the second stator length lₛ₂. In other words, the fifth TFM 550 is configured as a three-phase machine with the claw pole-style stator defining the second stator length lₛ₂ in an axial direction and with a rotor having a second rotor length lᵣ₂ that is shorter than the second stator length lₛ₂.

Considering the claw pole TFM, as the phase-B flux linkage is lower than the other two phases, the rotor length needs to be reduced to reduce the second order torque ripple and improve the performance of the machine. The shorter eighth rotor 560 of the fifth TFM 550 is configured to compensate for the imbalance in the flux linkages of the third TFM 500. To prove the concept, different cases are considered as shown in Table 2, below.

TABLE 2

| Design | Rotor Axial | Stator Axial | Rotor Length | | Rotor Length |
|---|---|---|---|---|---|
| Name | Length | Length | Difference (mm) | | Difference (%) |
| Case 8 | 51 mm | 50 mm | +1 | mm | +2% |
| Case 9 | 50 mm | 50 mm | 0 | mm | 0% |
| Case 10 | 49 mm | 50 mm | −1 | mm | −2% |
| Case 11 | 48 mm | 50 mm | −2 | mm | −4% |
| Case 12 | 47 mm | 50 mm | −3 | mm | −6% |
| Case 13 | 46 mm | 50 mm | −4 | mm | −8% |
| Case 14 | 45 mm | 50 mm | −5 | mm | −10% |
| Case 15 | 44 mm | 50 mm | −6 | mm | −12% |

The torque ripple harmonics were measured for the gear-shape stator TFM with varying rotor lengths indicated in Table 2. Rotors with an axial length shorter than an axial length of the stator were found to reduce the second order harmonics. Each of the designs studied with shorter rotors, ranging from the Case 10 design with rotor having the second rotor length lᵣ₂ in the axial direction about ninety-eight percent of the total axial length of the stator were found improvement in torque ripple harmonics for the three-phase TFM with the gear-shape stator. The Case 15 design, with the rotor having a second rotor length lᵣ₂ that is 12% shorter than the second stator length lₛ₂ of the stator was found to provide a maximum improvement in reducing the second order harmonics. In other words, the rotor having the second rotor length lᵣ₂ in the axial direction and which is about eighty-eight percent of the total axial length of the stator was found to provide the greatest improvement in torque ripple harmonics for the three-phase TFM with the gear-shape stator.

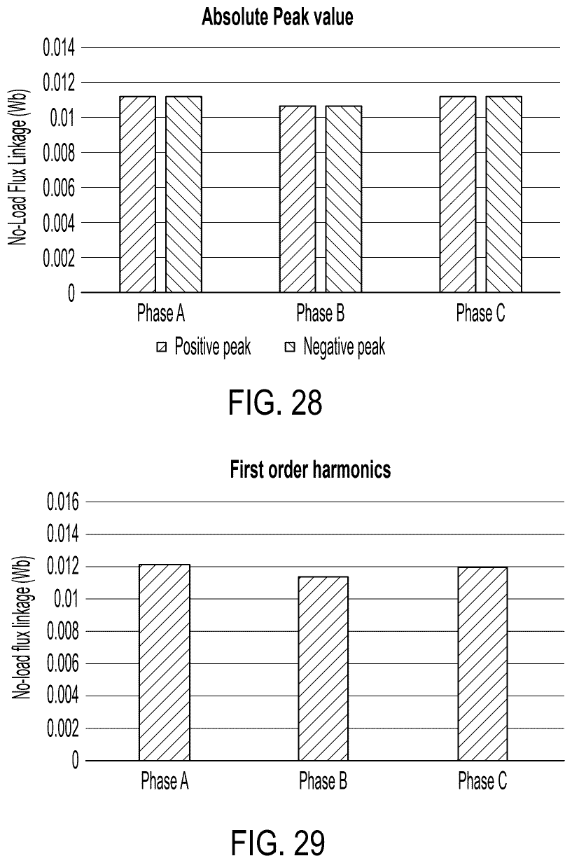

FIG. 28 shows a graph illustrating positive and negative peak values of flux linkage in the fifth TFM 550, with the claw pole-style stator and the reduced rotor with the Case 15 configuration, during no-load operation. As shown in FIG. 28, the no-load flux linkage has become almost equal for the case 15 condition, which may provide a corresponding reduction in the second order torque ripple. FIG. 29 shows a graph illustrating first order harmonics of flux linkage in the fifth TFM 550, with the claw pole-style stator and the reduced rotor with the Case 15 configuration, during no-load operation. Moreover, the first order harmonics of the no-load flux linkage are also more equal for the Case 15 configuration, as shown in FIG. 29.

The designs of the present disclosure also provide advantages in fault-tolerant design to accommodate a range of manufacturing tolerances for both TFMs with the gear-style stator and for TFMs with the claw-pole shape stator. During assembly of the TFM, due to manufacturing tolerances, alignment between the stator and rotor can vary. This gives rise to several cases of alignment between the stator and rotor. A thorough stack-up analysis was performed, and 4 worst-case misalignment scenarios were identified for the fourth TFM 450 with the gear-style stator, as shown in FIG. 24.

In a first worst-case scenario, a longest rotor (i.e. a rotor with the first rotor length lᵣ₁ at a high end of a corresponding range of manufacturing tolerances) is paired with a shortest stator (i.e. a stator with the first stator length lₛ₁ at a low end of a corresponding range of manufacturing tolerances) and the rotor is misaligned relative to the stator by at a maximum axial length in a first direction and for a corresponding range of manufacturing tolerances for axial alignment. For example, the second internal stator assembly 420 may have a first stator length lₛ₁ of 49.5 mm, the seventh rotor 460 may have a first rotor length lᵣ₁ of 51.1 mm, and the seventh rotor 460 may protrude in an axial direction beyond the second internal stator assembly 420 on each axial end by 0.46 mm and 1.14 mm, respectively. In a second worst-case scenario, the longest rotor is paired with the shortest stator, and the rotor is misaligned relative to the stator by at a maximum axial length in a second direction opposite the first direction and for a corresponding range of manufacturing tolerances for axial alignment. For example, the second internal stator assembly 420 may have a first stator length lₛ₁ of 49.5 mm, the seventh rotor 460 may have a first rotor length lᵣ₁ of 51.1 mm, and the seventh rotor 460 may protrude in an axial direction beyond the second internal stator assembly 420 on each axial end by 0.54 mm and 1.06 mm, respectively.

In a third worst-case scenario, a shortest rotor (i.e. a rotor with the first rotor length lᵣ₁ at a low end of a corresponding range of manufacturing tolerances) is paired with a longest stator (i.e. a stator with the first stator length lₛ₁ at a high end of a corresponding range of manufacturing tolerances) and the rotor is misaligned relative to the stator by at a maximum axial length in a first direction and for a corresponding range of manufacturing tolerances for axial alignment. For example, the second internal stator assembly 420 may have a first stator length lₛ₁ of 50.5 mm, the seventh rotor 460 may have a first rotor length lᵣ₁ of 50.9 mm, and the seventh rotor 460 may protrude in an axial direction beyond the second internal stator assembly 420 on one axial end by 0.46 mm. In a fourth worst-case scenario, the shortest rotor is paired with the longest stator, and the rotor is misaligned relative to the stator by at a maximum axial length in a second direction opposite the first direction and for a corresponding range of manufacturing tolerances for axial alignment. For example, the second internal stator assembly 420 may have a first stator length lₛ₁ of 50.5 mm, the seventh rotor 460 may have a first rotor length lᵣ₁ of 50.9 mm, and the seventh rotor 460 may protrude in an axial direction beyond the second internal stator assembly 420 on one axial end by 0.54 mm.

The torque ripple performance of the TFM will vary as the alignment varies between the stator and the rotor. A goal of the present disclosure is to provide a robust structure which is less susceptible to these manufacturing variations. To continue the analysis, the unequal rotor-stator length where the nominal rotor length is considered 1 mm longer than the stator length, similar worst-case scenarios are used to evaluate the output torque performance of the machine. For the unequal rotor-stator length, the worst-case torque ripple performance is only 5.43%, which is substantially lower than a worst-case of equal rotor-stator length TFM. This proves that the unequal rotor-stator TFM is less susceptible to manufacturing variations.

The present disclosure provides TFM designs with several different novel and advantageous features, including: unequal rotor-stator length for the TFM to reduce end-region leakage inherent to TFMs; longer rotor for the geared TFM and longer stator for claw pole TFM. The proposed design is applicable to any type of design where the stators are stacked on each other to make a multiphase machine; the proposed design improves the electromagnetic torque ripple performance of the TFM. The proposed design reduces the second order torque ripple harmonics of the TFM. The proposed design can be used for any slot/pole combination of the TFM. Through the proposed design the unbalance among no load flux linkages and BEMF voltages of phases can be reduced. Balanced BEMF voltages can be helpful to control the machine in an easier manner and the phase currents should be more equal than the unbalanced condition.

An aspect of the disclosed embodiments includes a transverse flux machine (TFM). The TFM includes: a rotor configured to rotate about an axis and having a plurality of permanent magnets arranged to generate a magnetic flux in a circumferential direction; and a stator including a plurality of stators cores stacked axially and each being configured to direct the magnetic flux in each of a radial direction and an axial direction, and each of the stator cores holding at least one winding. Each of the stator cores has one of: a gear shape or a claw-pole shape. The gear shape includes a first plurality of protrusions each extending in a radial direction toward the rotor, and a second plurality of protrusions each extending in a radial direction toward the rotor, with the second plurality of protrusions being axially spaced apart from the first plurality of protrusions with the at least one winding substantially entirely located axially between the first plurality of protrusions and the second plurality of protrusions. The claw-pole shape includes a first plurality of teeth each extending in a radial direction toward the rotor and wrapping over the at least winding in a first axial direction, and a second plurality of teeth each extending in a radial direction toward the rotor and wrapping over the at least winding in a second axial direction opposite the first axial direction. The rotor has a first axial length that is longer than a total axial length of the stator in case the stator cores have the gear shape, or the rotor has a second axial length that is shorter than the total axial length of the stator in case the stator cores have the claw-pole shape.

In some embodiments, each of the stator cores has the gear shape, and wherein the rotor has the first axial length that is longer than the total axial length of the stator.

In some embodiments, the first axial length of the rotor is at least about two percent longer than the total axial length of the stator.

In some embodiments, the first axial length of the rotor substantially equal to four percent longer than the total axial length of the stator.

In some embodiments, each of the stator cores has the claw-pole shape, and wherein the rotor has the second axial length that is shorter than the total axial length of the stator.

In some embodiments, the second axial length of the rotor is at most about ninety-eight percent of the total axial length of the stator.

In some embodiments, the second axial length of the rotor substantially equal to eighty-eight percent of the total axial length of the stator.

In some embodiments, the TFM has an internal rotor configuration with the stator extending annularly about the rotor.

In some embodiments, the TFM has an external rotor configuration with the rotor extending annularly about the stator.

In some embodiments, the at least one winding includes a first ring winding and a second ring winding each disposed in a shared stator core of the plurality of stator cores and each configured to conduct a corresponding current.

An aspect of the disclosed embodiments includes a steer-by-wire system for a vehicle. The steer-by-wire system includes a handwheel actuator coupled to apply a torque to a steering wheel. The handwheel actuator includes a transverse flux machine (TFM). The TFM includes: a rotor configured to rotate about an axis and having a plurality of permanent magnets arranged to generate a magnetic flux in a circumferential direction; and a stator including a plurality of stators cores stacked axially and each being configured to direct the magnetic flux in each of a radial direction and an axial direction, and each of the stator cores holding at least one winding. Each of the stator cores has one of: a gear shape or a claw-pole shape. The gear shape includes a first plurality of protrusions each extending in a radial direction toward the rotor, and a second plurality of protrusions each extending in a radial direction toward the rotor, with the second plurality of protrusions being axially spaced apart from the first plurality of protrusions with the at least one winding substantially entirely located axially between the first plurality of protrusions and the second plurality of protrusions. The claw-pole shape includes a first plurality of teeth each extending in a radial direction toward the rotor and wrapping over the at least winding in a first axial direction, and a second plurality of teeth each extending in a radial direction toward the rotor and wrapping over the at least winding in a second axial direction opposite the first axial direction. The rotor has a first axial length that is longer than a total axial length of the stator in case the stator cores have the gear shape, or the rotor has a second axial length that is shorter than the total axial length of the stator in case the stator cores have the claw-pole shape.

In some embodiments, each of the stator cores has the gear shape, and wherein the rotor has the first axial length that is longer than the total axial length of the stator.

In some embodiments, the first axial length of the rotor is at least about two percent longer than the total axial length of the stator.

In some embodiments, the first axial length of the rotor substantially equal to four percent longer than the total axial length of the stator.

In some embodiments, each of the stator cores has the claw-pole shape, and wherein the rotor has the second axial length that is shorter than the total axial length of the stator.

In some embodiments, the second axial length of the rotor is at most about ninety-eight percent of the total axial length of the stator.

In some embodiments, the second axial length of the rotor substantially equal to eighty-eight percent of the total axial length of the stator.

In some embodiments, the TFM has an internal rotor configuration with the stator extending annularly about the rotor.

In some embodiments, the TFM has an external rotor configuration with the rotor extending annularly about the stator.

In some embodiments, the at least one winding includes a first ring winding and a second ring winding each disposed in a shared stator core of the plurality of stator cores and each configured to conduct a corresponding current.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A transverse flux machine (TFM) comprising:
a rotor configured to rotate about an axis and having a plurality of permanent magnets arranged to generate a magnetic flux in a circumferential direction; and
a stator including a plurality of stators cores stacked axially and each being configured to direct the magnetic flux in each of a radial direction and an axial direction, and each of the stator cores holding at least one winding,
wherein each of the stator cores has one of:
a gear shape including a first plurality of protrusions each extending in a radial direction toward the rotor, and a second plurality of protrusions each extending in a radial direction toward the rotor, with the second plurality of protrusions being axially spaced apart from the first plurality of protrusions with the at least one winding substantially entirely located axially between the first plurality of protrusions and the second plurality of protrusions, and
a claw-pole shape including a first plurality of teeth each extending in a radial direction toward the rotor and wrapping over the at least winding in a first axial direction, and a second plurality of teeth each extending in a radial direction toward the rotor and wrapping over the at least winding in a second axial direction opposite the first axial direction,
wherein the rotor has a first axial length that is longer than a total axial length of the stator in case the stator cores have the gear shape, or the rotor has a second axial length that is shorter than the total axial length of the stator in case the stator cores have the claw-pole shape.

2. The transverse flux machine of claim 1, wherein each of the stator cores has the gear shape, and wherein the rotor has the first axial length that is longer than the total axial length of the stator.

3. The transverse flux machine of claim 2, wherein the first axial length of the rotor is at least about two percent longer than the total axial length of the stator.

4. The transverse flux machine of claim 2, wherein the first axial length of the rotor substantially equal to four percent longer than the total axial length of the stator.

5. The transverse flux machine of claim 1, wherein each of the stator cores has the claw-pole shape, and wherein the rotor has the second axial length that is shorter than the total axial length of the stator.

6. The transverse flux machine of claim 5, wherein the second axial length of the rotor is at most about ninety-eight percent of the total axial length of the stator.

7. The transverse flux machine of claim 5, wherein the second axial length of the rotor substantially equal to eighty-eight percent of the total axial length of the stator.

8. The transverse flux machine of claim 1, wherein the TFM has an internal rotor configuration with the stator extending annularly about the rotor.

9. The transverse flux machine of claim 1, wherein the TFM has an external rotor configuration with the rotor extending annularly about the stator.

10. The transverse flux machine of claim 1, wherein the at least one winding includes a first ring winding and a second ring winding each disposed in a shared stator core of the plurality of stator cores and each configured to conduct a corresponding current.

11. A steer-by-wire system for a vehicle, comprising:
a handwheel actuator coupled to apply a torque to a steering wheel;
the handwheel actuator including a transverse flux machine (TFM), including:
a rotor configured to rotate about an axis and having a plurality of permanent magnets arranged to generate a magnetic flux in a circumferential direction; and
a stator including a plurality of stators cores stacked axially and each being configured to direct the magnetic flux in each of a radial direction and an axial direction, and each of the stator cores holding at least one winding,
wherein each of the stator cores has one of:
a gear shape including a first plurality of protrusions each extending in a radial direction toward the rotor, and a second plurality of protrusions each extending in a radial direction toward the rotor, with the second plurality of protrusions being axially spaced apart from the first plurality of protrusions with the at least one winding substantially entirely located axially between the first plurality of protrusions and the second plurality of protrusions, and
a claw-pole shape including a first plurality of teeth each extending in a radial direction toward the rotor and wrapping over the at least winding in a first axial direction, and a second plurality of teeth each extending in a radial direction toward the rotor and wrapping over the at least winding in a second axial direction opposite the first axial direction,
wherein the rotor has a first axial length that is longer than a total axial length of the stator in case the stator cores have the gear shape, or the rotor has a second axial length that is shorter than the total axial length of the stator in case the stator cores have the claw-pole shape.

12. The steer-by-wire system of claim 11, wherein each of the stator cores has the gear shape, and wherein the rotor has the first axial length that is longer than the total axial length of the stator.

13. The steer-by-wire system of claim 12, wherein the first axial length of the rotor is at least about two percent longer than the total axial length of the stator.

14. The steer-by-wire system of claim 12, wherein the first axial length of the rotor substantially equal to four percent longer than the total axial length of the stator.

15. The steer-by-wire system of claim 11, wherein each of the stator cores has the claw-pole shape, and wherein the rotor has the second axial length that is shorter than the total axial length of the stator.

16. The steer-by-wire system of claim 15, wherein the second axial length of the rotor is at most about ninety-eight percent of the total axial length of the stator.

17. The steer-by-wire system of claim 15, wherein the second axial length of the rotor substantially equal to eighty-eight percent of the total axial length of the stator.

18. The steer-by-wire system of claim 11, wherein the TFM has an internal rotor configuration with the stator extending annularly about the rotor.

19. The steer-by-wire system of claim 11, wherein the TFM has an external rotor configuration with the rotor extending annularly about the stator.

20. The steer-by-wire system of claim 11, wherein the at least one winding includes a first ring winding and a second ring winding each disposed in a shared stator core of the plurality of stator cores and each configured to conduct a corresponding current.
